(19) United States
(12) Patent Application Publication
(10) Pub. No.: US 2007/0260533 A1
(43) Pub. Date: Nov. 8, 2007

(54) Method of trading securities

(76) Inventor: R. Scott Peden, Waco, TX (US)

Correspondence Address: Mark S. Leonardo, Esq.;Brown Rudnick Berlack Israels LLP, One Financial Center, Boston, MA, 02111, US

(21) Appl. No.: 11/429,519

(22) Filed: May 5, 2006

(51) Int. Cl. G06Q 40/00

(52) U.S. Cl. 705/37

(57) ABSTRACT

A method for facilitating a royalty on the sale of stock is disclosed. The method includes trading a share of a company stock between a seller and a buyer, and charging a fee for each share of company stock traded. The fee is accrued at the sale of the share of stock. The fee is paid by the seller of the share of the company stock. Each particular share of company stock includes indicia relating to the fee, wherein the indicia may include a legend or covenant indicating a payment of a royalty back to the issuing company. Generally, the fee is paid back to the issuing company of the share of stock or to a successor in interest thereof. The fee is collected and distributed via a stock exchange.

### BACKGROUND

1. Technical Field

The present disclosure generally relates to the field of securities trading, and more particularly, to a trading royalty process that provides revenue to a company through the subsequent sale of its stock post a public offering.

2. Background

The most common known manner of issuing securities is in the context of a public offering, and more particularly, an initial public offering or IPO. Private corporations use IPOs to create value and liquidity for their shareholders as well as to raise operating capital. When a company elects to have its shares publicly traded on a stock exchange, it engages an underwriter or investment banker to advise it and make a market for its particular stock.

With reference to prior art FIG. 1, there is disclosed a flow chart detailing typical proceeds 10 from the sale of stock or shares 16 in a public offering. Typically, an underwriter such as an investment banker 14 will purchase a certain number of shares 16 at a set price from the issuer, company or original shareholders 12, either by itself or through a syndicate of underwriters or investment bankers 14. These investment bankers 14 then market the shares 16 to their clients with the hope of selling the shares 16 at an amount greater than the amount paid to the company and/or its original shareholders 12.

Alternatively, the investment bank 14 may simply market the shares 16 and the company 12 receives whatever value the market bears from these sales. Although less common, the company 12 may market and sell the shares 16 itself without marketing assistance from an investment bank 14 and thus retain the proceeds from the sale of the shares 16.

In any of the above-described cases, the basic transaction is the same, that is, a company 12 sells ownership in itself (i.e., its stock 16) to investors (i.e., investment banks 14 or the public 18) who believe that the company's stock 16 will appreciate in value over time. In this way, the company 12 keeps the money for the stock 16 it sells. However, these initial investors 14, 18 may sell the stock 16 to other investors 14, 18. If the stock 16 has appreciated in value, sales by these initial investors at a higher price produce a profit. Likewise, if the stock 16 has depreciated in value, any sale would net a loss. This process continues throughout the life of the company 12, with investors 14, 18 buying and selling shares 16 of the company 12 at a profit or loss.

Outside the company buying back its own stock on the open market and reselling at a profit, a company only receives value and revenue from its stock through its original issuance and sale of the company stock to the original investors. Hence, such is a drawback with IPOs. Regardless of the amount of money initially raised by the issuer company, all subsequent trades as well as fees and gains thereon of the stock belongs to other parties. Accordingly, it would be beneficial if there was a trading royalty process or other vehicle that could provide revenue to a company by the subsequent sale of its stock post a public offering.

### SUMMARY

Accordingly, a method for facilitating a royalty on the sale of stock is disclosed. The method includes trading a share of a company stock between a seller and a buyer, and charging a fee for each share of company stock traded. The fee is accrued at the sale of the share of stock. The fee is paid by the seller of the share of the company stock. Each particular share of company stock includes indicia relating to the fee, wherein the indicia may include a legend or covenant indicating a payment of a royalty back to the issuing company. Generally, the fee is paid back to the issuing company of the share of stock or to a successor in interest thereof. The fee is collected and distributed via a stock exchange.

Also disclosed is a method of trading securities including the sale of shares of stock onto a public market. The shares of stock include a legend or covenant indicating a royalty fee. The method provides for the collection of the royalty fee for each of the shares sold on the public market and paying the royalty fee to the issuer of the shares of stock. The royalty fee is paid by a seller of the share of stock. The royalty fee is paid back to an issuing company or successor in interest of the issuing company of the share of stock. The royalty fee is collected and distributed via a stock exchange.

### BRIEF DESCRIPTIONS OF THE DRAWINGS

The objects and features of the present disclosure, which are believed to be novel, are set forth with particularity in the appended claims. The present disclosure, both as to its organization and manner of operation, together with further objectives and advantages, may be best understood by reference to the following description, taken in connection with the accompanying drawings wherein:

FIG. 1 is a flow chart detailing prior art proceeds from the sale of stock in a public offering and subsequent stock sales without the use of the trading royalty process in accordance with the principles of the present disclosure; and

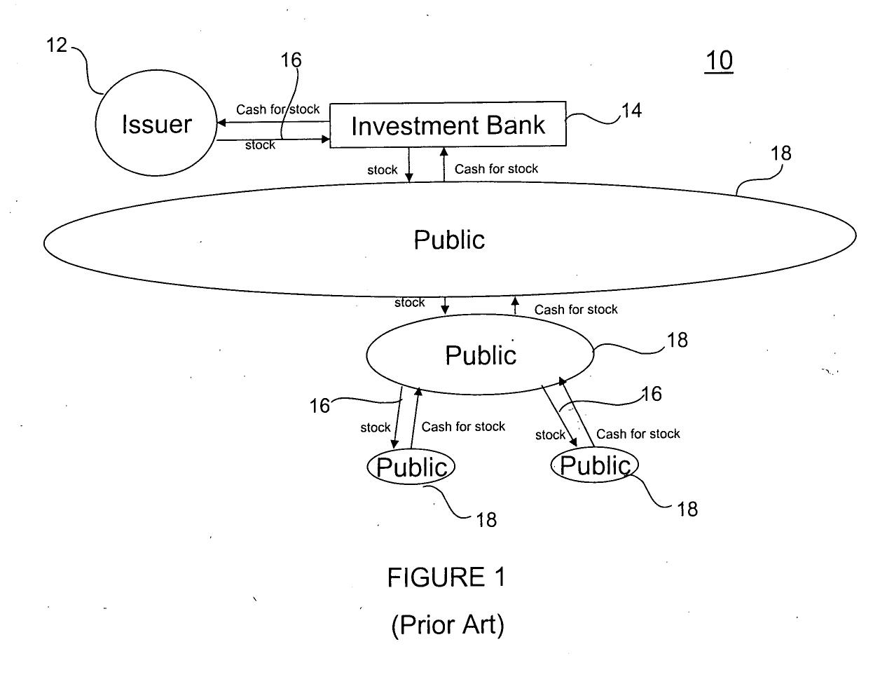

FIG. 2 is a flow chart detailing the proceeds from the sale of stock in a public offering and subsequent stock sales using the trading royalty process in accordance with the principles of the present disclosure.

### DETAILED DESCRIPTION OF EXEMPLARY EMBODIMENTS

The exemplary embodiments of the trading royalty process are disclosed and discussed in terms of capitalization of equity markets and stock trading. It is contemplated that the trading royalty process disclosed in the present disclosure may be employed in other stock or security offerings made by public and private companies. Regardless of the type of stock or equity class, the methods of the present disclosure can be employed to provide a trading royalty.

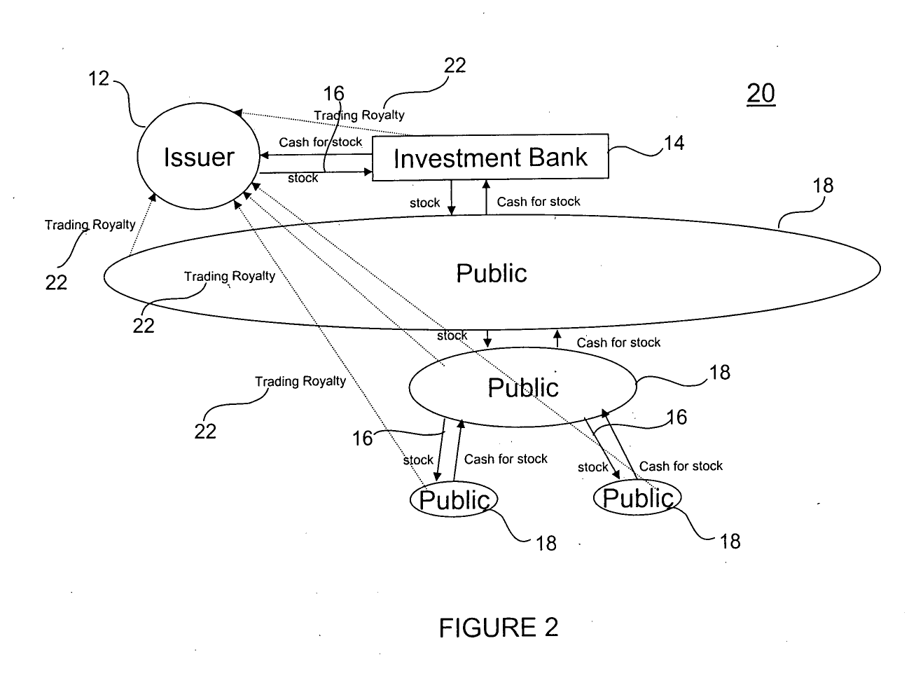

As will be explained in greater detail below with reference to FIG. 2, the trading royalty process of the present disclosure is a vehicle designed to provide value to a party (for example, the company, an investment banker or other third party) by the subsequent sales of the stock or equity of the company.

The stock of public companies is traded on various stock exchanges throughout the world. In the United States, for example, the New York Stock Exchange and the NASDAQ Exchange are the largest and most popular exchanges on which a company may be listed. These exchanges have their own qualifications for being listed as a stock as well as their own rules regarding trades. In addition, the Securities and Exchange Commission (“SEC”) regulates the operations of these stock exchanges. Although regulated by government agencies, stock exchanges are private organizations and are responsible for accurately accounting for and completing the stock trades of companies, which are listed on the exchanges as well as for the collection and payment of SEC fees. As a practical matter, the fees collected for the trading royalty process will be collected by the various stock exchanges through private agreement with those companies in a manner substantially similar to that used for the collection and payment of trading commissions and SEC fees.

As shown in FIG. 2, and by way of a non-limiting example, the trading royalty process 20 of the present disclosure provides an interest or royalty 22 in the stock 16, which is retained by the issuer or its assignees, such as, for example, investment bankers taking the issuer public. The interest or royalty 22 is noted in the prospectus and on the share or stock certificates. The trading royalty process 20 provides that the issuer retain, in perpetuity, a modest, stated royalty 22, for example, $0.01, although more or less is contemplated herein, from each and every trade of each and every share of stock 16. As discussed below, the trading royalty 22 is deducted by and accounted for by stock traders in the same way that sales and buy commissions and SEC fees are accounted. Since many investment bankers also have relationships with trading companies or affiliates, accounting of such royalties 22 would be easily adaptable. The issuer 12 of the stock 16 would have the right to audit clearing houses to ensure proper payment of the royalties 22. The seller of the shares or stock 16, which may include, for example, the investment banker 14 or the public 18, shall pay the royalties 22 much like is now done with sales or commission fees on the sale stock 16. This add-on royalty 22 much like the sales commission would not materially or adversely affect the share trading price of the stock 16. Moreover, the trading royalty 22 will inhibit thinly capitalized, low priced companies from artificially inflating their volume by conducting trades between affiliates because the trading royalty is an add-on cost based on volume. If the trading royalty is equal to or a high percentage of the price of the stock, it will act as a cost disincentive to those who do not truly want to purchase the stock. The trading royalty is neutral to the market value if there is true demand for the stock and if the royalty is a small percentage of the stock's price.

Referring to Table 1, and by way of non-limiting example, there is illustrated an average royalty 22 value to a sample company of non-operational income per day using the trading royalty process 20 of the present disclosure at a royalty rate, for example, of $0.01 per share per trade.

TABLE 1
Sample Company Proceeds Using the Trading Royalty Process

| Yahoo ® | Microsoft ® | Google ® |
|---|---|---|
| $194,608 | $655,927 | $100,279 |

The trading royalty business process 20 cannot be applied to stock which has already been issued by a company because such stock was sold without any reservation of interest. However, the trading royalty business process 20 can be utilized by companies with existing stock if they issue a new class of stock (i.e., stock which is different from the shares which currently trade) or issue new shares in place of old shares. Typically, this re-issuance of shares is due to a stock split, company name change or some other change to the capital structure of the company. In order for a company to utilize the trading royalty business process 20, while its stock is currently trading, it must reissue new stock to existing shareholders and broadly disclose that the new shares retain a trading royalty reservation of interest. This re-issuance can be made separately from or in conjunction with any other change to the stock, such as a corporate name change or stock split. Upon the re-issuance of the new stock, the new certificates which have the reservation of the trading royalty will be issued a new CUSIP number in order to distinguish the new shares from the old shares. In this way, the existence of the trading royalty reservation and their qualification for use in this business process 20 can be easily identified by the various stock exchanges and by the public.

In an alternate embodiment, using the trading royalty process 20 of the present disclosure can provide companies with a trading royalty 22 even when there is a high volume of sellers in a stock which is traditionally harmful to the market capitalization of a company. While the share price in such an situation is reduced by market forces, the harmful effects of large selling volume on a company is somewhat ameliorated due to the non-operating income produced from the trading royalty generated by the high volume of sales.

In yet an alternate embodiment, investment bankers 14, eager for additional sources of income, may with the trading royalty process 20 of the present disclosure, for example, structure the IPO stock with a trading royalty 22 and require the issuer 12 to assign a percentage (e.g., 50%) of the royalty 22 back to the investment bankers 14. In an alternate arrangement, for example, the investment bankers 14 may lower their underwriting fees in exchange for participation with the trading royalty 22. In such an arrangement, every trade made by a stock trader, for example, would provide a royalty 22 to the company 12 and/or investment banker 14.

In operation, the trading royalty process 20 of the present disclosure could operate with and part of currently established rules and authorities. By way of non-limiting example, and pursuant to Section 31 of the Securities Exchange Act of 1934 (“Exchange Act”), incorporated herein by reference in its entirety, the SEC collects fees and assessments on securities transactions occurring on national securities exchanges and by or through members of national securities associations (collectively, “self-regulatory organizations” or “SROs”). The mechanism by which these fees are collected is governed by the rules and regulations of each exchange as well as Rule 31 promulgated under the Exchange Act. Because the automated systems are already in place to account for such fees on a per transaction basis and to assess miscellaneous fees on a per transaction basis, the collection and accounting of trading royalties 22 can be accomplished from each national securities exchange or national securities association in a manner similar to that used to collect Rule 31 fees.

Paragraph (e) stipulates that the Rule 31 fees shall be paid: (1) on or before March 15, with respect to transactions and sales occurring during the period beginning on the preceding September 1 and ending at the close of the preceding December 31; and (2) on or before September 30, with respect to transactions and sales occurring during the period beginning on the preceding January 1 and ending at the close of the preceding August 31. By private agreement with each national securities exchange or national securities association, and in return for fees to such exchanges or associations, trading royalties 22 can be paid on the same dates using the existing software, mechanisms and procedures currently in place for payment of Rule 31 fees to the SEC. Stocks 16 which were subject to the trading royalty 22 could be marked on their symbol with an extension, for example, “.TR” (e.g., ABC.TR) or by CUSIP notation in order to permit automated trading programs to easily identify and capture the royalty 22 from the stock trade. The royalty 22 would then be paid to the company 12 or its assignee on the same schedule as set forth in Rule 31 of the Exchange Act.

It will be understood that various modifications may be made to the embodiments disclosed herein. Therefore, the above description should not be construed as limiting, but merely as exemplification of the various embodiments. Those skilled in the art will envision other modifications within the scope and spirit of the claims appended hereto.

What is claimed is:

1. A method for facilitating a royalty on the sale of stock comprising the steps of:
trading a share of a company stock between a seller and a buyer; and
charging a fee for each share of company stock traded.

2. The method for facilitating a royalty on the sale of stock according to claim 1, wherein said fee is paid by the seller of said share of company stock.

3. The method for facilitating a royalty on the sale of stock according to claim 1, wherein each of said share of company stock includes indicia relating to said fee.

4. The method for facilitating a royalty on the sale of stock according to claim 1, wherein said share of company stock includes a legend or covenant indicating a payment of a royalty back to the company.

5. The method for facilitating a royalty on the sale of stock according to claim 1, wherein said fee is paid back to the issuing company of said share of stock.

6. The method for facilitating a royalty on the sale of stock according to claim 1, wherein said fee is paid back to a successor in interest to the issuing company of said share of stock.

7. The method for facilitating a royalty on the sale of stock according to claim 1, wherein said fee is collected via a stock exchange.

8. A business method comprising issuing a share of stock with a restrictive covenant to a royalty fee, wherein said royalty fee is accrued at the sale of said share of stock.

9. The business method according to claim 8, wherein said royalty fee is paid by a seller of said share of stock.

10. The business method according to claim 8, wherein said share of stock includes indicia relating to said royalty fee.

11. The business method according to claim 8, wherein said share of stock includes a legend or covenant indicating payment of said royalty fee to an issuer of the share of stock.

12. The business method according to claim 8, wherein said royalty fee is paid back to an issuing company of said share of stock.

13. The business method according to claim 8, wherein said royalty fee is paid back to a successor in interest to an issuing company of said share of stock.

14. The business method according to claim 8, wherein said royalty fee is collected via a stock exchange.

15. A method of trading securities comprising the steps of:
selling shares of stock to a public market;
providing said shares of stock with a covenant to a royalty fee;
collecting said royalty fee for each of said shares sold on the public market; and
paying said royalty fee to the issuer of said shares of stock.

16. The method of trading securities according to claim 15, wherein said royalty fee is paid by a seller of said share of stock.

17. The method of trading securities according to claim 15, wherein said share of stock includes indicia relating to said royalty fee.

18. The method of trading securities according to claim 15, wherein said royalty fee is paid back to an issuing company of said share of stock.

19. The method of trading securities according to claim 15, wherein said royalty fee is paid back to a successor in interest to an issuing company of said share of stock.

20. The method of trading securities according to claim 15, wherein said royalty fee is collected via a stock exchange.
